(19) United States
(12) Patent Application Publication
(10) Pub. No.: US 2009/0126115 A1
(43) Pub. Date: May 21, 2009

(54) Remote Controller

(75) Inventors: Ulrich Doering, Saalfeld (DE); Steffen Loeser, Unterwellenborn OT Gosswitz (DE)

Correspondence Address: FISH & RICHARDSON PC, P.O. BOX 1022, MINNEAPOLIS, MN, 55440-1022, US

(73) Assignee: TRUMPF MEDIZIN SYSTEME GMBH, Saalfeld (DE)

(21) Appl. No.: 12/270,359

(22) Filed: Nov. 13, 2008

(30) Foreign Application Priority Data
Nov. 13, 2007 (DE) 102007055465.8

(51) Int. Cl. A61G 7/015; G08C 19/16; A61G 7/018; G05B 15/02

(52) U.S. Cl. 5/616; 340/825.69; 700/275

(57) ABSTRACT

A remote controller for an adjustable support apparatus for supporting a patient includes an input device configured to accept control commands for adjusting a support apparatus for supporting a patient, at least one sensor configured to detect a pick-up of the remote controller by a user, and a transmitter device configured to transmit the control commands to the support apparatus for supporting a patient. The detection of the pick-up of the remote controller by the user activates the remote controller.

### CROSS-REFERENCE TO RELATED APPLICATION

This application claims priority under 35 U.S.C. § 119(a) to German patent application number 10 2007 055 465.8, filed on Nov. 13, 2007, the entire contents of which is hereby incorporated herein by reference in its entirety and for all purposes.

### TECHNICAL FIELD

This disclosure relates to a remote controller for controlling an apparatus configured to support a patient.

### BACKGROUND

Apparatuses for supporting a patient are known. Examples of such apparatuses include operating tables and treatment tables for therapeutic and surgical procedures. These apparatuses also can be used for performing diagnostic techniques, and, in particular, for obtaining images of the patient with, for example, computed tomography techniques or with the aid of magnetic resonance imaging. A patient can be supported in a stable manner on a support surface of the apparatus for supporting the patient. The support surface can be adjusted. For example, the entire support surface can be displaced in a horizontal or vertical direction, or individual portions of the support surface such as, for example, a back part or a leg part of the support surface, can be pivoted about a horizontal pivot axis.

Control commands for adjusting the support surface can be entered by means of a remote controller that is coupled to the apparatus in a wire-free (e.g., wireless) or wire-bound (e.g., wired) manner. For example, an infrared or a radio connection can be used to couple the remote controller to the apparatus. The remote controller has an input device by which the user can enter control commands for adjusting the support surface. These control commands are then transmitted from the remote controller to the apparatus in the wire-free or wire-bound manner.

The support surface of the apparatus should not be adjusted unintentionally. In some known remote controllers, to ensure that control commands cannot be entered unintentionally by, for example, an object being placed on the input device of the remote controller, a key first is pressed to activate the remote controller before a control command is entered. In some known controllers, a plurality of keys are pressed simultaneously in order to activate the remote controller before the remote controller can be used to provide a control command for the apparatus.

### SUMMARY

The techniques discussed in this disclosure relate to a remote controller that provides control commands to an apparatus for supporting a patient in such a way that the remote controller can be activated in a simple manner while also preventing accidental activation of the remote controller.

In one general aspect, a remote controller for an adjustable support apparatus for supporting a patient includes an input device configured to accept control commands for adjusting a support apparatus for supporting a patient, at least one sensor configured to detect a pick-up of the remote controller by a user, and a transmitter device configured to transmit the control commands to the support apparatus for supporting a patient. The detection of the pick-up of the remote controller by the user activates the remote controller.

Implementations can include one or more of the following features. Activation of the remote controller can include activating the transmitter device such that the transmitter device transmits the control commands. Activation of the remote controller can include activating the input device such that the control commands are accepted. The remote controller can include a plurality of sensors configured to detect pick-up of the remote controller by a user, and the remote controller can be activated only when at least two sensors detect the pick-up of the remote controller by the user. In some implementations, control commands are accepted only after the at least one sensor has detected pick-up of the remote controller by a user.

The remote controller also can include a display device. The display device can be activated as a function of a sensor signal of the at least one sensor. The input device can include at least one input element, and the remote controller also can include at least one lighting device for illuminating the at least one input element. The lighting device can be adapted to be activated as a function of a sensor signal of the at least one sensor.

The at least one sensor of the remote controller that is configured to detect a pick-up of the remote controller by a user can include at least one proximity sensor. At least one proximity sensor can be a capacitive sensor. The remote controller can have at least two proximity sensors that are disposed at a spacing from one another.

The remote controller also can include a housing. The housing can include side regions that are directed away from one another, and a proximity sensor can be disposed in each of the side regions. The remote controller also can include a housing that has a trough-like lower part that forms a standing surface for placing the remote controller on a support, and the at least one proximity sensor can be disposed at a spacing from the standing surface such that placing the remote controller on a support does not activate the at least one proximity sensor. The remote controller also can have a housing having walls of non-uniform thickness and including a region of reduced wall thickness. The at least one proximity sensor can be disposed on the region of reduced wall thickness.

The remote controller also can include a sensor device configured to detect a movement of the remote controller. The sensor device can be adapted to detect a movement pattern of the remote controller, and the remote controller also can include an evaluation unit configured to compare the detected movement pattern with a predefined movement pattern. The sensor device configured to detect a movement of the remote controller can include at least one acceleration sensor. The sensor device configured to detect a movement of the remote controller can include a plurality of acceleration sensors, the acceleration sensors can each be configured to detect an acceleration pattern, and the remote controller can be activated only when all the acceleration sensors detect the same acceleration pattern.

The remote controller also can include a sensor device configured to detect a direction of movement of the remote controller relative to the support apparatus, and an evaluation unit configured to provide a control signal for adjusting at least one portion of the support apparatus based on the detected direction of movement. In some implementations, the transmitter device is activated only after the at least one sensor has detected pick up of the remote controller by the user. The remote controller also can include an electronic activation unit configured to activate the remote controller based on the detection of the pick-up of the remote controller.

In another general aspect, a remote controller for an adjustable apparatus for supporting a patient includes an input device configured to accept control commands, a sensor device configured to detect a direction of movement relative to an adjustable apparatus for supporting a patient, and an evaluation unit configured to provide a control signal for adjusting at least one portion of the adjustable apparatus based on the detected direction of movement.

In yet another general aspect, a system includes an adjustable support apparatus configured to support a patient and a remote controller. The adjustable support apparatus includes an adjustable surface, a motor coupled to the adjustable surface and configured to move the adjustable surface in response to a control signal, and a control unit coupled to the motor and configured to generate the control signal based on a signal received from a remote controller. The remote controller includes an input device configured to accept control commands for adjusting a support apparatus for supporting a patient, at least one sensor configured to detect a pick-up of the remote controller by a user, and a transmitter device configured to transmit the control commands to the adjustable support apparatus for supporting a patient. The detection of the pick-up of the remote controller by the user activates the remote controller.

In yet another general aspect, an adjustable support apparatus is adjusted with a remote controller. A first signal is received from a proximity sensor housed in a remote controller. The remote controller is configured to generate a command signal to adjust a support apparatus for supporting a patient. Whether the remote controller is held by a user is determined based on the first signal. A second signal that represents an acceleration profile of the remote controller is received. The second signal is compared to a reference acceleration profile to determine whether the remote controller is moving, and if the remote controller is moving and if the remote controller is held by the user, the remote controller is activated.

Implementations can include one or more of the following features. Activating the remote controller can include transmitting the control commands from the remote controller. Activating the remote controller can include accepting an input command corresponding to an adjustment of the support apparatus.

In another implementation, the remote controller has at least one sensor that detects pick-up of the remote controller by a user. That is, the sensor identifies when the remote controller is grasped by the user. In this implementation, the at least one sensor provides a sensor signal and the remote controller is activated, so that control signals can now be provided to the apparatus with the remote controller. Thus, in this implementation, the remote controller is activated by the user grasping the remote controller. Accordingly, it is therefore possible to activate the remote controller without pressing an activation key on the remote controller, entering a special key sequence in the form of an identification number and/or simultaneously pressing a plurality of keys of the remote controller. Such a remote controller can be activated by the user in a relatively simple manner while also ensuring that control commands are provided to the apparatus for supporting a patient only after activation of the remote controller has taken place.

In some implementations, the remote controller has a plurality of sensors that detect pick-up of the remote controller by the user. In these implementations, the provision of control signals for the apparatus are activated only when at least two sensors detect pick-up of the remote controller by a user. For example, provision can be made for a plurality of sensors, each of which detect pick-up of the remote controller by a user, to be disposed over the periphery of the remote controller. The remote controller is activated only when at least two sensors provide a sensor signal that corresponds to the remote controller being picked up. As a result, it can be possible to prevent a single faulty signal of a sensor leading to unintentional activation of the remote controller.

In some implementations, control commands can be effectively entered into the remote controller or accepted by the remote controller only after at least one sensor has detected pick-up of the remote controller by a user. Thus, an entry operation performed before the remote controller is picked up does not lead to transmission of a control command from the remote controller to the apparatus for supporting a patient. Control commands can instead be effectively entered by a user and accepted by the remote controller only after the user has picked up the remote controller.

In order to facilitate handling of the remote controller, the remote controller can include a display device. For example, the display device can be a liquid crystal display. Entered control commands can be displayed to the user visually on the display device. The display device can be useful when the remote controller is configured to handle bidirectional signals. The remote controller is configured to handle bidirectional signals when the remote controller can transmit control signals to the support apparatus and also receive control signals transmitted to the remote controller from the support apparatus. In implementations in which the remote controller is configured to handle bidirectional signals, the display device can display properties of the apparatus on the display device, such as, for example, a current orientation of the support surface.

In order to prevent unintentional power consumption by the remote controller via the display device, the display device can be activated as a function of a sensor signal of the at least one sensor that detects pick-up of the remote controller by a user. The remote controller usually has a rechargeable battery, and the display device requires power in order to be able to display information. Thus, in order to prevent unintentional power consumption, the display device is activated only after a user has picked up the remote controller.

In order to facilitate entry of a control command, the remote controller has, in some implementations, at least one lighting device for illuminating at least one input element of the input device. In order to prevent unintentional power consumption by the lighting device, the lighting device can be configured to be activated as a function of a sensor signal of the at least one sensor that detects pick-up of the remote controller by a user. It is possible, for example, for the input device to have a keypad and for the individual keys of the keypad to be illuminated by light-emitting diodes. However, the light-emitting diodes are activated only after a user has picked up the remote controller. Thus, unintentional power consumption by the light-emitting diodes can be avoided.

In some implementations, at least one sensor that detects pick-up of the remote controller by the user is a proximity sensor. The proximity sensor detects the proximity of the hand (or other body part) of the user or a device operated by the user (such as a prosthetic) to the remote controller. The proximity sensor can be a contactless (e.g., a contact-free) sensor such that the user does not have to make direct contact with the sensor to activate the sensor. The proximity sensor can be, for example, an optical sensor, an ultrasound sensor or an electromagnetic sensor. The optical sensor evaluates the reflection of an optical signal, and the ultrasound sensor evaluates the reflection of an ultrasound signal. The electromagnetic sensor can have a resonant circuit whose oscillation frequency changes as the user gets closer. Thus, monitoring the frequency of the circuit allows detection of the proximity of the user. In one implementation, at least one proximity sensor is a capacitive sensor. Capacitive proximity sensors can be used in a structurally simple manner to detect in a contact-free fashion that the hand of a user is approaching the remote controller.

The remote controller can include at least two proximity sensors that are disposed at a spacing from one another. As a result, it is possible to detect that the hand of the user is approaching different regions of the remote controller, which provides the possibility of being able to detect in a contact-free fashion that the remote controller is completely grasped by the user, in order to then activate the remote controller as explained above.

The remote controller includes a housing having side regions that are directed away from one another. A proximity sensor can be disposed on each side region. For example, a proximity sensor can be positioned on an upper face and a lower face of the housing, it being possible to activate the remote controller only when the two proximity sensors provide a sensor signal. Alternatively or additionally, a proximity sensor can be disposed on the longitudinal and transverse sides of the housing that are directed away from one another.

In some implementations, the remote controller has a housing with a trough-like lower part that forms a standing surface for placing the remote controller on a support, and at least one proximity sensor is disposed at a spacing from the standing surface. As a result of the spacing, it is possible to ensure, in a structurally simple manner, that the remote controller cannot be activated by being placed on the support. In particular, at least one proximity sensor is disposed at a spacing from the standing surface, and the spacing is such that the proximity sensor cannot detect the support when the remote controller is placed on the support because the proximity sensor assumes a known spacing from the support.

In order to able to reliably detect pick-up of the remote controller by the user in implementations that use proximity sensors, the remote controller has a housing with at least one region of reduced wall thickness, and the at least one proximity sensor is disposed in the region of reduced wall thickness of the housing. Provision may be made, for example, for the housing to have, on its inside, pocket-like recesses in which a proximity sensor is disposed in each case.

As an alternative or in addition to the use of at least one proximity sensor, the remote controller can also have a sensor device for detecting a movement of the remote controller. If the remote controller assumes an inoperative position, the remote controller is deactivated; activation of the remote controller occurs when the sensor device detects a movement of the remote controller.

In some implementations, a movement pattern of the remote controller can be detected by the sensor device and can be compared with a predefined movement pattern. A movement pattern is understood to mean a specific acceleration profile. An arrangement of this type is based on the finding that pick-up of the remote controller by a user is typically associated with a specific movement pattern. The remote controller is activated only after the sensor device has identified a movement pattern in the event of a movement of the remote controller, as typically takes place when the remote controller is picked up by a user, so that control commands can then be provided to the apparatus for supporting a patient. The identified movement pattern can be compared with a predefined movement pattern, which can be stored in a memory element, to prevent the remote controller being activated by an unintentional movement. An unintentional movement can take place, for example, when the remote controller falls to the floor.

In order to detect a movement of the remote controller, the sensor device can have at least one acceleration sensor. In some implementations, the time profile of the acceleration of the remote controller (e.g., the acceleration of the remote controller as a function of time) can be detected, because this permits, as explained above, comparison with a predefined acceleration profile of the remote controller. The predefined acceleration profile can be an acceleration profile that is typically present when the remote controller is picked up by a user. The sensor device can have a plurality of acceleration sensors, and the provision of control commands for the apparatus can be activated only when all the acceleration sensors detect the same acceleration pattern.

In some implementations, the remote controller has a sensor device for detecting a direction in which movement of the remote controller relative to the apparatus takes place, and also an evaluation unit that is coupled to the sensor device. The evaluation unit provides the apparatus with a control signal for adjusting the support surface in accordance with the detected direction of movement. Acceleration sensors can be used to detect the movement direction, a specific orientation relative to the apparatus initially being predefined for the remote controller, and the acceleration then being determined in relation to the predefined orientation. To this end, the apparatus and the remote controller can have a gyroscope system that is initially synchronized. It is then possible, for example, to adjust the support surface in the horizontal direction in a simple manner as soon as the sensor device detects a corresponding horizontal acceleration of the remote controller. The user, therefore, only has to move the remote controller in an accelerated fashion in the horizontal direction in order to adjust the support surface in the horizontal direction. Correspondingly, accelerated movement in the vertical direction, that is to say raising or lowering of the remote controller, can lead to vertical adjustment of the support surface, and pivoting of the remote controller about a horizontal pivot axis can generate a control signal for pivoting a support surface portion, which is predefined, for example by pressing a specific key, about a horizontal or vertical pivot axis.

Implementations of the described techniques can include hardware, a method or process, a device, an apparatus, a remote controller, or a system. The details of one or more implementations are set forth in the accompanying drawings and the description below. Further features and advantages of the techniques discussed above ensue from the following description of examples, from the figures, and from the claims. The individual features can be put into effect in a variant of the techniques discussed either individually, or in a plurality of any kind of combination.

### BRIEF DESCRIPTION OF THE DRAWINGS

FIG. 1 is a side view of an apparatus for supporting a patient and a remote controller for adjusting the apparatus.

FIG. 2 is a perspective view of the remote controller of FIG. 1.

FIG. 3 is a perspective sectional view along A-A′ of the remote controller of FIG. 2.

FIG. 4 is a perspective view of an underside of the remote controller of FIG. 2 with a lower housing removed.

FIG. 5 is a block diagram of a system that includes the apparatus and the remote controller of FIGS. 1-4.

### DETAILED DESCRIPTION

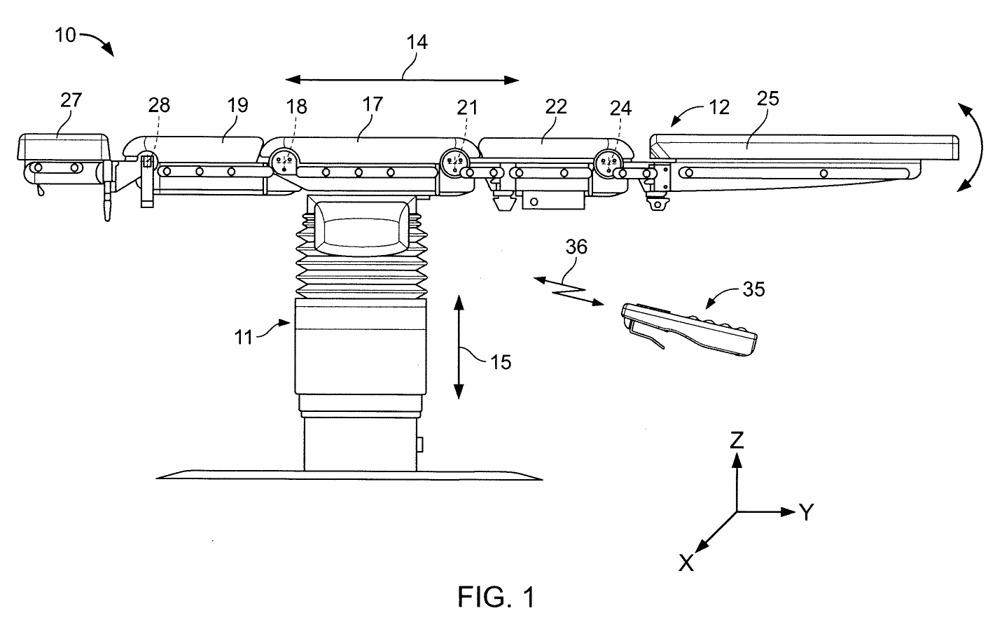

Referring to FIG. 1, an apparatus for supporting a patient and a remote controller for adjusting the apparatus are shown. In the example of FIG. 1, the apparatus for supporting the patient is an operating table 10. In other examples, the apparatus for supporting the patient can be another platform such as a treatment table used in therapeutic or diagnostic procedures. For example, the apparatus for supporting the patient can be a table, chair, or bed that supports the patient while images of the patient are obtained with a computed tomography technique or magnetic resonance imaging.

The operating table 10 includes a vertically adjustable supporting pillar 11, and a table top 12 mounted on the supporting pillar 11. The table top 12 forms a support surface for a patient. As indicated by the double-headed arrow 14, the table top 12 can be adjusted relative to the supporting pillar 11 in the horizontal direction. Such an adjustment can be referred to as a horizontal adjustment. The horizontal adjustment can be made parallel to the longitudinal direction of the table top 12 (e.g., in a direction “Y”), as illustrated in FIG. 1, but it is additionally possible to provide a horizontal adjustment transverse to the longitudinal direction (e.g., in a direction “X”) of the table top 12. The table top 12 also can be adjusted in the vertical direction together with the supporting pillar 11. In the example shown in FIG. 1, the vertical direction is indicated by the double-headed arrow 15 and is a direction “Z.”

The table top 12 includes a base segment 17 that is connected to the supporting pillar 11. A back segment 19 is mounted on the base segment 17 such that the back segment 19 can pivot about a horizontal pivot axis 18. A pelvis segment 22 is mounted on the base segment 17 such that the pelvis segment 22 can pivot about a, likewise, horizontally oriented pivot axis 21. A leg segment 25 is mounted such that the leg segment 25 can pivot about a, once again, horizontally oriented pivot axis 24 on that side of the pelvis segment 22 that is directed away from the base segment 17. The back element 19 has mounted on a side that is directed away from the base segment 17 a head segment 27 that can be pivoted about a horizontal pivot axis 28. Electric motors, which are integrated into the table top 12 but are not illustrated in FIG. 1, are used to pivot the individual segments 17, 19, 22, 25 and 27 of the table top 12. Additional electric motors, which are integrated into the supporting pillar 11 and into the base segment 17, can be used to adjust the table top 12 in the horizontal direction and in the vertical direction. A central control unit of the operating table 10, which is not illustrated in FIG. 1, is used to control the electric motors.

The operating table 10 has an associated remote controller 35 which, in the example shown in FIG. 1, is connected to the central control unit of the operating table 10 in a wire-free (or wireless) manner via, for example, a radio and/or infrared connection 36. The connection 36 can be unidirectional or bidirectional. The central control unit is coupled to a memory device and a processor.

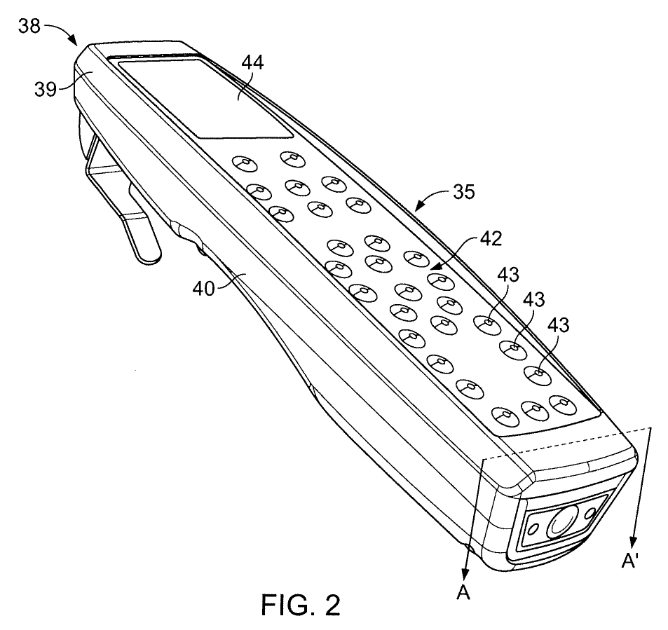

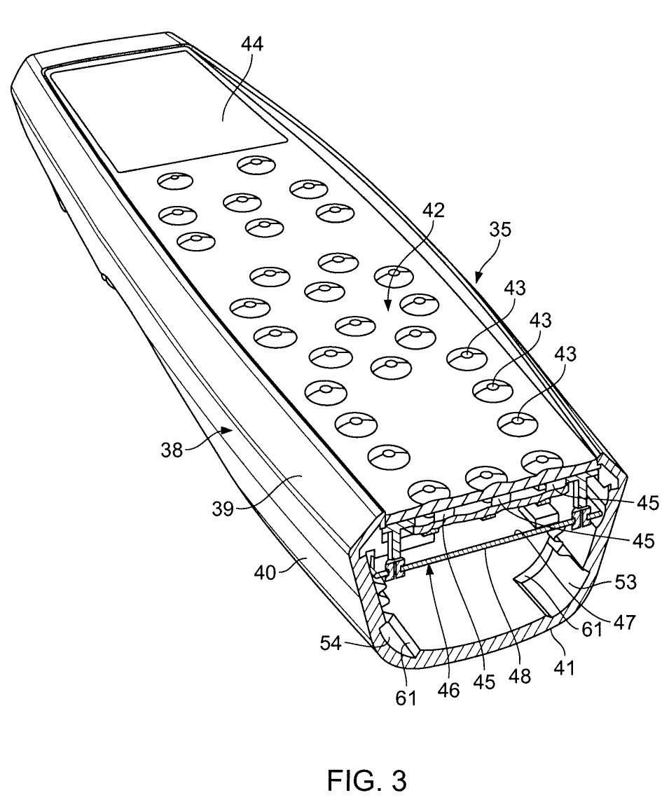

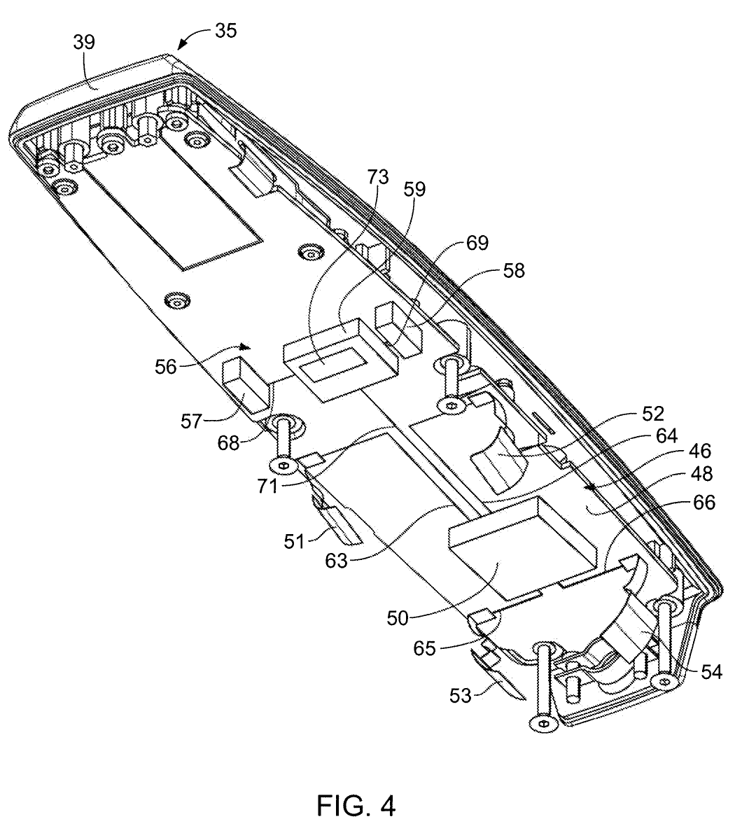

Referring to FIGS. 2 to 4, an example of the remote controller 35 is shown. In particular, FIG. 2 shows a perspective view of the remote controller 35, FIG. 3 shows a perspective side view of the remote controller 35 along the line A-A′ shown in FIG. 2, and FIG. 4 shows a sectional perspective view of the remote controller 35 with a bottom portion of the remote controller 35 removed. Referring to FIG. 2, the remote controller 35 has a housing 38 that has an upper part 39 that covers a trough-like lower part 40. The upper part 39 includes a keypad 42 with a multiplicity of keys 43 and a display 44.

Referring to FIG. 3, a printed circuit board 46 is disposed within the housing 38. The printed circuit board 46 has an upper face 47 and a lower face 48. Electrical components are fitted on both on the upper face 47 and the lower face 48. A transceiver device, which is not illustrated, is disposed on the upper face 47 of the printed circuit board 46. The transceiver device helps to provide the connection 36 by transmitting signals from the remote controller 35 and receiving signals at the remote controller 35. A user can use the keypad 42 to enter control commands that are transmitted from the remote controller 35, via the radio and/or infrared connection 36, to the operating table 10 for the purpose of adjusting the table top 12 and the segments 17, 19, 22, 25 and 27 of the table top 12. In order for the remote controller 35 to provide control commands to the operating table 10 and/or accept command controls entered into the remote controller 35 by the user, first the remote controller 35 is activated.

Referring to FIG. 4, the remote controller 35 has an electronic activation unit 50 that is configured to activate the remote controller 35. In the example shown in FIG. 4, the electronic activation unit 50 is disposed on the lower face 48 of the printed circuit board 46, and the electronic activation unit 50 has a plurality of associated sensors that detect pick-up of the remote controller 35 by a user. Pick-up of the remote controller 35 can occur when the user intentionally grasps, grabs, holds, or otherwise makes contact with the remote controller 35. The sensors used are firstly four capacitive sensors 51, 52, 53 and 54, each of which forms a contact-free proximity sensor, and secondly a sensor device 56 that includes two acceleration sensors 57, 58 and an evaluation unit 59.

The four capacitive sensors 51, 52, 53 and 54 detect pick-up of the remote controller 35 by a user. That is, the sensors 51, 52, 53 and 54 produce a sensor signal that indicates whether the remote controller 35 is grasped by the user. When the remote controller 35 is grasped, at least one of the sensors 51, 52, 53 and 54 provides a sensor signal and the remote controller 35 is activated. Once the remote controller 35 is activated, control signals can be provided to the operating table 10 through the remote controller 35. Thus, in this example, the remote controller 35 is activated by the user grasping the remote controller 35. Accordingly, it is therefore possible to activate the remote controller 35 without pressing an activation key on the remote controller 35, entering a special key sequence in the form of, for example, an identification number and/or to simultaneously pressing a plurality of keys of the remote controller 35. Thus, the remote controller 35 can be activated by the user in a relatively simple manner while also ensuring that control commands are provided to the operating table 10 and/or accepted by the remote controller 35 only after activation of the remote controller 35 has taken place.

In some implementations, the remote controller 35 has a plurality of sensors (such as the sensors 51, 52, 53 and 54) that detect pick-up of the remote controller 35 by a user, and the remote controller 35 is activated only when at least two sensors detect pick-up of the remote controller 35 by a user. For example, each of the sensors 51, 52, 53 and 54 can detect pick-up of the remote controller 35 by the user and the sensors 51, 52, 53 and 54 can be disposed over a periphery of the remote controller 35. The remote controller 35 is activated only when at least two of the sensors 51, 52, 53 and 54 provide a sensor signal that corresponds to the remote controller 35 being picked up. As a result, unintentional activation of the remote controller 35 by a single faulty signal can be prevented.

In some implementations, control commands can be effectively entered into the remote controller 35 or accepted by the remote controller 35 only after at least one of the sensors 51, 52, 53 and 54 has detected pick-up of the remote controller 35 by a user. Therefore, an entry operation performed before the remote controller 35 is picked up by the user does not result in transmission of a control command from the remote controller 35 to the operating table 10. Control commands can instead be effectively entered by a user only after the user has picked up the remote controller 35.

In the example discussed above, the sensors 51, 52, 53 and 54 are capacitive, contact-free proximity sensors. A proximity sensor detects the proximity of the hand (or other body part) of the user or a device operated by the user (such as a prosthetic) to the remote controller 35. The proximity sensor is a contact-free sensor such that the user does not have to make direct contact with the sensor to activate the sensor. The capacitive proximity sensors can include an oscillator circuit that has a capacitance that changes as a function of the user's distance from the capacitive sensor. In some implementations, the proximity sensor can be, for example, an optical sensor, an ultrasound sensor or an electromagnetic sensor. The optical sensor can evaluate the reflection of an optical signal to determine the proximity of the user, an ultrasound sensor can evaluate the reflection of an ultrasound signal to determine the proximity of the user, and the electromagnetic sensor can have a resonant circuit whose oscillation frequency changes as the user gets closer. In some implementations, each of the sensors 51, 52, 53 and 54 can be a different type of proximity sensors.

In some implementations, the remote controller 35 can include at least two proximity sensors that are disposed in different portions of the housing 38 and at a spacing from one another. As a result of the spacing of the at least two proximity sensors, it is possible to detect that the hand of the user is approaching different regions of the remote controller 35. Thus, whether the remote controller 35 is completely grasped by the user can be determined without the user having to make physical contact with the proximity sensors. In this implementation, the remote controller 35 can be activated only when it is determined that the user is completely grasping the remote controller 35.

Referring to FIG. 3, the capacitive sensors 51, 52, 53 and 54 are disposed in a pocket-like recess 61 in the housing lower part 40. Thus, the capacitive sensors are each disposed in a region of reduced wall thickness of the housing lower part 40. Referring to FIG. 4, if the housing 38 is grasped by a user's hand from below, the capacitive sensors 51, 52, 53 and 54 in each case provide the activation unit 50 with a sensor signal. To provide the sensor signal from the capacitive sensors 51, 52, 53 and 54 to the activation unit 50, the capacitive sensors 51, 52, 53 and 54 are connected to the activation unit 50 via corresponding sensor lines 63, 64, 65, and 66.

Acceleration sensors 57 and 58 detect acceleration of the remote controller 35, and, thus, detect a movement of the remote controller 35 relative to the surroundings of the remote controller 35. The acceleration sensors 57 and 58 are connected to the evaluation unit 59 via sensor lines 68 and 69, respectively. The evaluation unit 59 is electrically connected to the activation unit 50 via a signal line 71. At least one of the acceleration sensors 57 and 58 can be used to detect a movement of the remote controller 35. In some implementations, the time profile of the acceleration of the remote controller 35 (e.g., the acceleration of the remote controller 35 as a function of time) can be detected by the acceleration sensors 57 and 58. The time profile of the acceleration of the remote controller 35 can be compared with a predefined acceleration profile of the remote controller 35. The time profile of the acceleration of the remote controller 35 can be referred to as the acceleration profile of the remote controller 35. The predefined acceleration profile can be an acceleration profile that is typically present when the remote controller 35 is picked up by a user. In some implementations, the provision of control commands for the operating table 10 is activated only when both of the acceleration sensors 57 and 58 detect the same acceleration pattern.

If the remote controller 35 is picked up by the user, the remote controller 35 experiences a typical sequence of acceleration processes. These acceleration processes are detected by the acceleration sensors 57, 58 and passed to the evaluation unit 59. The evaluation unit 59 has a memory element 73 in which a typical acceleration profile, as is present when the remote controller 35 is picked up by the user, is stored. The memory element 73 also stores instructions that, when executed by a processor coupled to the evaluation unit 59, process the data detected by the acceleration sensors 57 and 58. A current acceleration profile, detected by the acceleration sensors 57, 58, can therefore be computed and compared with the stored acceleration profile by the evaluation unit 59. The processor coupled to the evaluation unit 59 executes instructions from the memory element 73 such that the processor performs the comparison of the current acceleration profile and the stored acceleration profile. The comparison of the current acceleration profile with the stored acceleration profile can be performed by mathematical evaluation, such as a correlation. If there is a sufficient degree of correspondence between the current acceleration profile and the stored acceleration profile, the evaluation unit 59 sends an enable signal to the activation unit 50 via the signal line 71. The correlation can be relatively coarse or low because an acceleration profile resulting from a user grasping the remote controller 35 is quite different from an acceleration profile that results from unintentional movement of the remote controller 35, such as the remote controller 35 falling to the floor. If this enable signal is present and at the same time the capacitive sensors 51, 52, 53 and 54 detect the presence of the hand of the user on the outside of the housing lower part 40, the remote controller 35 is activated by the activation unit 50. Once the remote controller 35 is activated by the activation unit 50, control commands can be provided from the remote controller 35 to the operating table 10 and/or accepted by the remote controller 35. Erroneous transmission of control commands, which result, for example, from an object having been placed on the keypad 42, can therefore be avoided.

In contrast, if the remote controller 35 is placed or rests only on a support such as the table top 12, by way of a standing surface 41 of the remote controller 35, the remote controller 35 is not activated. Thus, in some implementations, control commands cannot yet be transmitted from the remote controller 35 to the operating table 10. In some implementations, the remote controller 35 has a trough-like housing lower part 40 that forms the standing surface 41, and the standing surface 41 is used for placing the remote controller 35 on a support. At least one proximity sensor is disposed within the housing 38 at a spacing from the standing surface 41. The spacing is such that the proximity sensor is not activated by the placement of the remote controller 35 on the standing surface 41. For example, the proximity sensor is usually sensitive to objects within 2 millimeters (mm) of the proximity sensor. Thus, if the distance between the proximity sensor from the standing surface 41 is greater than 2 mm, the proximity sensor does not sense the standing surface 41. As a result, it is possible to ensure, in a structurally simple manner, that the remote controller 35 cannot be inadvertently activated by being placed on a support.

Thus, control commands are provided to the operating table 10 only after a user has activated the remote controller 35 by picking up the remote controller 35. However, once the remote controller 35 is activated, the table top 12 can be adjusted in a simple manner. For example, in order to adjust the table top 12, the user selects to adjust either the table top 12 in its entirety or a segment 17, 19, 22, 25 or 27 by pressing a corresponding key 43. The user then moves the remote controller 35 in the desired direction in which the table top 12 or the selected segment 17, 19, 22, 25 or 27 is to be moved.

In some implementations, the remote controller 35 has a sensor device for detecting a direction in which the remote controller 35 moves relative to the operating table 10 and an evaluation unit 59 coupled to the sensor device. The acceleration sensors 57 and 59 can be configured to detect the direction of the movement of the remote controller 35. The evaluation unit 59 provides the operating table 10 with a control signal for adjusting the table top 12 in accordance with the detected direction of movement of the remote controller 35.

In particular, the evaluation unit 59 identifies, from the acceleration sensors 57 and 58, the direction in which the remote controller 35 is moved relative to the table top 12, and provides a control signal that is transmitted to the operating table 10 so that the operating table top 12 and/or the desired segment 17, 19, 22, 25 or 27 is adjusted in accordance with the movement direction of the remote controller 35. In order to coordinate the orientation of the remote controller 35 with the orientation of the table top 12 such that the movement of the remote controller 35 relative to this orientation can be detected, a certain spatial direction is predefined for the remote controller 35 in a first step. The predefined spatial direction can be determined by, for example, gyroscope systems of the operating table 10 and the remote controller 35 being synchronized in advance. The gyroscope systems can be located in the supporting pillar 11 of the operating table 10 and/or in the remote controller 35. Once the remote controller 35 is synchronized and activated, adjustment of the table top 12 or adjustment of the segments 17, 19, 22, 25, 27 is relatively simple.

Referring to FIG. 3, the activation of the remote controller 35 also results in the display 44 being supplied with power and the keys 43 being illuminated by a light-emitting diode (LED) 45 that is disposed beneath the keys 43. The display 44 can facilitate handling of the remote controller 35. The display 44 can be, for example, a liquid crystal display. Control commands entered into the remote controller 35 can be displayed to the user visually on the display 44. Additionally, in implementations in which the remote controller 35 is configured to handle bidirectional signals, the display 44 displays properties of the table top 12 such as, for example, a current orientation of the support surface, on the display 44. The remote controller 35 is configured to handle bidirectional signals when the remote controller 35 can transmit control signals to the operating table 10 and also receive signals transmitted to the remote controller 35 from the operating table 10.

In order to prevent unintentional power consumption by the remote controller 35 via the display 44, in some implementations, the display 44 is activated as a function of a sensor signal of the at least one sensor (such as the sensors 51, 52, 53 and 54) that detects pick-up of the remote controller 35 by a user. The remote controller 35 usually has a rechargeable battery, and the display 44 uses power from the battery (or other power source) in order to display information. Thus, in order to prevent unintentional power consumption by the display 44 when the remote controller 35 is not activated, the display 44 is activated only after a user has picked up the remote controller 35.

In order to facilitate entry of a control command, the remote controller 35 has, in some implementations, at least one lighting device for illuminating at least one input element of the input device. The at least one lighting device can be the LED 45 that illuminates the keys 43 from below. Additionally or alternatively, the keypad 42 can be illuminated by one or more lighting devices. In order to prevent unintentional power consumption by the lighting devices, the lighting devices can be configured to be activated only when the user picks up the remote controller 35 by a user.

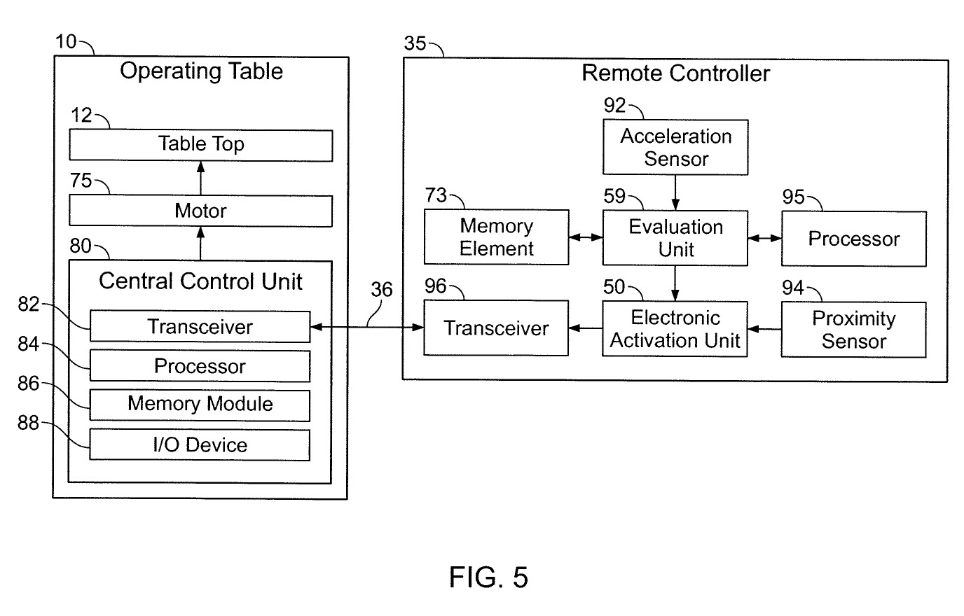

Referring to FIG. 5, a block diagram of a system that includes the operating table 10 and the remote controller 35 for adjusting the support apparatus operating table the connection 36 is shown. The operating table 10 includes the table top 12, a motor 75, and a central control unit 80. The central control unit 80 provides a control signal to the motor 75, and, in response to the control signal, the motor 75 moves the table top 12. The motor 75 can be an electric motor, and, in some implementations, the motor 75 can include more than one motor. The motor 75 can be integrated into the operating table 10. For example, the motor 75 can be a part of the table top 12, the motor 75 can be part of the supporting pillar 11, and/or the base segment 17.

The central control unit 80 includes a transceiver 82, a processor 84, a memory module 86, and an I/O device 88. The transceiver 82 receives signals from a transceiver 96 of the remote controller 35. The signals from the remote controller 35 represent control commands sent from the remote controller 35 when the remote controller 35 is activated. The control commands can represent a desired adjustment to the operating table 10. For example, the control commands can represent a command to adjust the table top 12. The processor 84 analyzes the received control signal using operations and instructions stored in the memory module 86 to generate the control signal. The control signal is provided to the motor 75, which adjusts the table top 12 accordingly. The central control unit 80 also can include the I/O device 88 to allow a user, machine, or automated process to interact with the central control unit 80 directly. The I/O device 88 can be, for example, a mouse, keyboard, a network connection, or a bi-directional data interface.

The remote controller 35 provides signals to the operating table 10 through the connection 36. The remote controller 35 includes an acceleration sensor 92, the memory element 73, the evaluation unit 59, a processor 95, a proximity sensor 94, the electronic activation unit 50, and a transceiver 96. The electronic activation unit 50 activates the remote controller 35 such that the remote controller 35 can transmit signals and/or accept commands entered into the remote controller 35 by the user. The electronic activation unit 50 can include a switch or other device that controls whether the remote controller 35 is activated such that, for example, the remote controller 35 can transmit signals.

The acceleration sensor 92 can include one or both of the acceleration sensors 57 and 58. The proximity sensor 94 can include one or more of the proximity sensors 51, 52, 53 and 54. The sensors 92 and 94 each produce a sensor signal in response to stimulus detected by the sensors 92 and 94. As discussed above with respect to FIG. 4, the evaluation unit 59 receives the sensor signals from the acceleration sensor 92. The evaluation unit 59 is coupled to the memory element 73, which stores acceleration profiles known to be associated with a user picking up, or otherwise grasping, the remote controller 35. The evaluation unit 59 is also coupled to a processor 95. The electronic evaluation unit 59 receives signals from the sensor 92, accesses the acceleration profiles in the memory element 73, and compares the sensor signal to the accessed acceleration profiles to determine whether the signal received from the sensor 92 is indicative of the remote controller being picked up by the user. If the evaluation unit 59 determines that the remote controller 35 has been picked up, an enable signal is sent from the evaluation unit 59 to the electronic activation unit 50. The proximity sensors 94 are coupled to the electronic activation unit 50 such that a sensor signal sent from the proximity sensors 94 to the electronic activation unit 50 can activate the remote controller 35.

If the enable signal from the electronic evaluation unit 59 is received at the electronic activation unit 50 at the same time, or nearly the same time, as the sensor signal from the proximity sensor 94 indicates that the user has picked up the remote controller 35, the electronic activation unit 50 activates the remote controller 35. When the remote controller is activated, the transceiver 96 generates and transmits a control signal to the operating table 10 such that the operating table 10 is positioned according to the control signal.

The memory module 86 and the memory element 73 are an electronic memory modules. The memory module 86 and the memory element 73 can be non-volatile or persistent memory. The memory module 86 and the memory element 73 can be volatile memory, such as RAM. In some implementations, the memory module 86 and the memory element 73 can include both non-volatile and volatile portions or components.

Each of the processors 84 and 95 can be a processor suitable for the execution of a computer program such as a general or special purpose microprocessor, and any one or more processors of any kind of digital computer. Generally, a processor receives instructions and data from a read-only memory or a random access memory or both. In some implementations, either or both of the processors 84 and 95 include more than one processor.

The foregoing description is intended to illustrate and not limit the scope of the techniques discussed above. Other aspects, advantages, and modifications are within the scope of the following claims.

What is claimed is:

1. A remote controller for an adjustable support apparatus for supporting a patient, the remote controller comprising:
an input device configured to accept control commands for adjusting a support apparatus for supporting a patient,
at least one sensor configured to detect a pick-up of the remote controller by a user, and
a transmitter device configured to transmit the control commands to the support apparatus for supporting a patient,
wherein the detection of the pick-up of the remote controller by the user activates the remote controller.

2. The remote controller of claim 1, wherein activation of the remote controller comprises activating the transmitter device such that the transmitter device transmits the control commands.

3. The remote controller of claim 1, wherein activation of the remote controller comprises activating the input device such that the control commands are accepted.

4. The remote controller of claim 1, wherein the remote controller comprises a plurality of sensors configured to detect pick-up of the remote controller by a user, and the remote controller is activated only when at least two sensors detect the pick-up of the remote controller by the user.

5. The remote controller of claim 1, wherein control commands are accepted only after the at least one sensor has detected pick-up of the remote controller by a user.

6. The remote controller of claim 1, further comprising a display device.

7. The remote controller of claim 6, wherein the display device is activated as a function of a sensor signal of the at least one sensor.

8. The remote controller of claim 1, wherein the input device includes at least one input element, and further comprising at least one lighting device for illuminating the at least one input element.

9. The remote controller of claim 8, wherein the lighting device is adapted to be activated as a function of a sensor signal of the at least one sensor.

10. The remote controller of claim 1, wherein the at least one sensor configured to detect a pick-up of the remote controller by a user comprises at least one proximity sensor.

11. The remote controller of claim 10, wherein at least one proximity sensor is a capacitive sensor.

12. The remote controller of claim 10, wherein the remote controller has at least two proximity sensors that are disposed at a spacing from one another.

13. The remote controller of claim 10, further comprising a housing, and wherein:
the housing includes side regions that are directed away from one another, and
a proximity sensor is disposed in each of the side regions.

14. The remote controller of claim 10, further comprising a housing having a trough-like lower part that forms a standing surface for placing the remote controller on a support, and wherein the at least one proximity sensor is disposed at a spacing from the standing surface such that placing the remote controller on a support does not activate the at least one proximity sensor.

15. The remote controller of claim 10, further comprising a housing, the housing having walls of non-uniform thickness and including a region of reduced wall thickness, and wherein the at least one proximity sensor is disposed on the region of reduced wall thickness.

16. The remote controller of claim 1, further comprising a sensor device configured to detect a movement of the remote controller.

17. The remote controller of claim 16, wherein the sensor device is adapted to detect a movement pattern of the remote controller, and the remote controller further comprises an evaluation unit configured to compare the detected movement pattern with a predefined movement pattern.

18. The remote controller of claim 16, wherein the sensor device configured to detect a movement of the remote controller comprises at least one acceleration sensor.

19. The remote controller of claim 16, wherein:
the sensor device configured to detect a movement of the remote controller comprises a plurality of acceleration sensors,
the acceleration sensors are each configured to detect an acceleration pattern, and
the remote controller is activated only when all the acceleration sensors detect the same acceleration pattern.

20. The remote controller of claim 1, further comprising:
a sensor device configured to detect a direction of movement of the remote controller relative to the support apparatus, and
an evaluation unit configured to provide a control signal for adjusting at least one portion of the support apparatus based on the detected direction of movement.

21. The remote controller of claim 1, wherein the transmitter device is activated only after the at least one sensor has detected pick up of the remote controller by the user.

22. The remote controller of claim of claim 1, further comprising an electronic activation unit configured to activate the remote controller based on the detection of the pick-up of the remote controller.

23. A remote controller for an adjustable apparatus for supporting a patient, the remote controller comprising:
an input device configured to accept control commands,
a sensor device configured to detect a direction of movement relative to an adjustable apparatus for supporting a patient, and
an evaluation unit configured to provide a control signal for adjusting at least one portion of the adjustable apparatus based on the detected direction of movement.

24. A system comprising:
an adjustable support apparatus configured to support a patient, the adjustable support apparatus comprising:
an adjustable surface,
a motor coupled to the adjustable surface and configured to move the adjustable surface in response to a control signal, and
a control unit coupled to the motor and configured to generate the control signal based on a signal received from a remote controller; and
the remote controller comprising:
an input device configured to accept control commands for adjusting a support apparatus for supporting a patient,
at least one sensor configured to detect a pick-up of the remote controller by a user, and
a transmitter device configured to transmit the control commands to the adjustable support apparatus for supporting a patient,
wherein the detection of the pick-up of the remote controller by the user activates the remote controller.

25. A method of adjusting, with a remote controller, an adjustable support apparatus for supporting a patient, the method comprising:
receiving a first signal from a proximity sensor housed in a remote controller, the remote controller being configured to generate a command signal to adjust a support apparatus for supporting a patient;
determining, based on the first signal, whether the remote controller is held by a user;
receiving a second signal that represents an acceleration profile of the remote controller;
comparing the second signal to a reference acceleration profile to determine whether the remote controller is moving; and
if the remote controller is moving and if the remote controller is held by the user, activating the remote controller.

26. The method of claim 25, wherein activating the remote controller comprises transmitting the control signal from the remote controller.

27. The method of claim 25, wherein activating the remote controller comprises accepting an input command corresponding to an adjustment of the support apparatus.
